(19) United States
(12) Patent Application Publication
(10) Pub. No.: US 2016/0166359 A1
(43) Pub. Date: Jun. 16, 2016

(54) DENTAL IMPLANT WITH CORONAL GROOVE STRUCTURE

(71) Applicant: BEGO IMPLANT SYSTEMS GMBH & CO., KG, Bremen (DE)

(72) Inventors: Matthias FLACH, Koblenz (DE); Stephan MEYER, Bremen (DE)

(73) Assignee: BEGO IMPLANT SYSTEMS GMBH & CO., KG, Bremen (DE)

(21) Appl. No.: 14/905,117

(22) PCT Filed: Jul. 17, 2014
(86) PCT No.: PCT/EP2014/065435

§ 371 Date: Jan. 14, 2016

(30) Foreign Application Priority Data
Jul. 17, 2013 (DE) 10 2013 107 630.0

(51) Int. Cl. A61C 8/00

(52) U.S. Cl. CPC A61C 8/0025

(57) ABSTRACT

The invention relates to a dental implant, comprising an implant body which extends in a longitudinal direction from an apical end to a coronal end and which has a first bone anchoring surface extending from the apical end to a transition portion lying between the apical and the coronal end, and a second bone anchoring surface extending from the transition portion to the coronal end, said second bone anchoring surface having at least one groove extending in a circumferential direction of the second bone anchoring surface, said groove being defined in the radially inward direction by a groove bottom surface and on both sides in the axial direction by groove flank surfaces extending from the groove bottom surface to an outer surface.

The invention relates to a dental implant, comprising an implant body which extends in a longitudinal direction from an apical end to a coronal end and which has a first bone anchoring surface extending from the apical end to a transition portion lying between the apical and the coronal end, and a second bone anchoring surface extending from the transition portion to the coronal end, said second bone anchoring surface having at least one groove extending in a circumferential direction of the second bone anchoring surface, said groove being defined in the radially inward direction by a groove bottom surface and on both sides in the axial direction by groove flank surfaces extending from the groove bottom surface to an outer surface.

Such dental implants are part of a dental implant system used to replace extracted teeth. The dental implant is the part of the dental implant system that is inserted into the jawbone and which is meant to provide firm anchoring. In addition to the dental implant, a dental implant system also includes a superstructure which may be joined to the dental implant and which represents the visible part of the tooth replacement system. This superstructure typically comprises a tooth abutment portion which may be joined to the dental implant, and in this regard a screw which is inserted through an opening in the tooth abutment portion and fastened in an internal thread in the dental implant may typically be used. A crown may also be attached to the tooth abutment portion, said crown imitating the original geometry of the replaced tooth and aimed at providing good functionality and esthetics in combination with the other adjacent and opposite teeth of the patient.

Besides these dental implant systems, dental implant systems are also known in which the tooth abutment portion and the crown are fastened as an integral component to the dental implant.

Various constructions for fastening the tooth abutment portion to the dental implant are known. One widespread method consists in securing the tooth abutment portion against rotation in the dental implant by a form-fitting, anti-rotational connection, and fastening it my means of a screw in an internal thread in the dental implant. However, other methods of attachment are also known, for example a cemented attachment that manages without screw fastening and which can be embodied as a conical plug connection.

The success of treatment with a dental implant system is measured in terms of the functionality of the implanted system over a period of use. The aim, as far as possible, is that the dental implant system is of lifelong benefit to the patient. One key factor behind the success of a dental implant system is the successful and reliable anchorage of the dental implant in the jawbone. A commonly used dental implant construction involves providing on the dental implant an external thread which may be self-tapping. This external thread is screwed into a prepared hole bored in the jawbone and can thus provide stability immediately after implantation. This is referred to as primary stability. The anchorage of the dental implant can be further and permanently improved by bone reorganization and bone growth into microstructures that are formed by surface roughness in this bone anchoring portion and by the macro-roughness formed by the thread, thus resulting in a high level of permanent anchorage (referred to as secondary stability).

The thread geometry formed in the region of a bone anchoring surface of such a dental implant must meet specific requirements. Whereas thread geometries that imitate well-known thread geometries of mechanical construction elements, such as machine screws or wood screws, were originally used in dental implants, the trend for dental implants used nowadays is to adapt the thread geometry specifically to the properties of the bone material in which the thread is anchored. Furthermore, when designing the thread geometry for dental implant as used nowadays, consideration is also given to the specific stresses to which a dental implant is exposed. These stresses are characterized by strong compressive forces on the dental implant in the longitudinal direction, coupled with radially acting forces which are caused by bending moments and the exertion of lateral forces on the tooth abutment portion, and differ essentially in that respect from the loads which act on osteosynthesis screws, for example. Such osteosynthesis screws are likewise anchored in bone material, but they have to absorb what are primarily tensile forces in the longitudinal direction, coupled with shear forces in the radial direction.

Bone inhomogeneities and variations in bone quality pose a special challenge for designing the geometry of the bone anchoring surface. Every jawbone has a basic inhomogeneity that is characterized by thicker bone substance being present toward the surface of the bone than inside the jawbone, where the bone substance is more porous. However, these inhomogeneities may be altered by ossification processes around a foreign body such as an implant, which must be taken into consideration when designing the geometry of the bone anchoring surface. The distribution of dense and less dense bone portions within this inhomogeneity may vary from patient to patient and also differs from one tooth position to the next in a jawbone. The bone quality itself may likewise vary from patient to patient, as may the capacity to integrate a dental implant securely by osseointegration. Modern dental implants should be so designed in this regard that they provide good primary and secondary stability for all patients, from young trauma patients to older patients with planned dental prostheses.

A dental implant system in which the bone anchoring surface is subdivided into an apical, cylindrical portion and a coronal, conical portion is known from EP 0668751 B1. A micro-roughness in the form of a microthread or circumferential groove is provided in the conical portion. In the apical bone anchoring surface of this dental implant, a conventional, self-tapping thread is provided.

Another dental implant geometry is known from EP 2145600 A1. In this dental implant, a bone anchoring surface having an external thread on the bone anchoring surface is provided, said thread being self-tapping. The geometry of this bone anchoring surface is slightly conical, not only with regard to the outer envelope at the maximum outer diameter of the crests of the thread, but also with regard to the root of the thread. This thread in the bone anchoring surface serves as anchorage not only in the more porous, deeper bone portion, but also in the denser surface portion of the bone. The implant also has a soft tissue portion, in which a plurality of circumferential grooves are disposed which are intended to foster a tight connection with soft tissue, in order to prevent bacteria from penetrating into the bone-implant interface.

Another screw-type implant is known from EP 0646362 B1. In this screw-type implant, the bone anchoring surface is subdivided into an apical and a coronal portion. A thread of larger depth is provided in the apical portion, and a thread of lower depth is provided in the coronal portion.

Although good primary and secondary stability can be achieved in many cases with implants of such prior art design, it has been found that the load-bearing capacity of the implant could still be improved, and that sufficient primary and secondary stability for unusual bone qualities and bone inhomogeneities, in particular, can not be achieved in many cases by implants having these kinds of bone anchoring surface.

The object of the present invention is therefore to provide a dental implant which provides improved primary and secondary stability, even in cases of poor bone quality and unfavorable jawbone inhomogeneities in the implantation area.

This object is achieved, according to the invention, with a dental implant of the type initially described, in which the depth of the groove in the radial direction is greater than 40 micrometers and the angle of the groove flank surfaces to the radial direction is less than 30°.

The dental implant according to the invention is based on the realization that the thread geometries of dental implants used hitherto are based, in a manner that is not well adapted to the bone as far as certain geometrical characteristics are concerned, on thread geometries that are used for other materials such as wood or metallic materials. Whereas it is generally advantageous with such screws with a thread geometry suitable for wood or metal, if a flank angle of more than 30°, in particular a flank angle of 45° or more is provided, in order, for example, to balance out any tolerance errors between the external thread and the internal thread and to prevent the screw from jamming when used in metal, and in the case of wood screws to avoid cutting and notching effects caused by a sharp edge between the outer diameter and the flank portion, which reduce stability, this is geometry which is neither needed nor advantageous for the bone. The inventor has realized that, by providing such a flank angle of more than 30° and in particular of more than 45°, the resilience of the dental implant against axial forces is substantially reduced at the implant-bone-interface because the bone has significant elastic properties at the microscopic level in the region where the bone attaches to the dental implant. Due to these elastic properties, the bone may be pressed out from the groove area by a wedging effect when an axial pressure is exerted. This process is made possible and is intensified to a substantial and detrimental extent by a flank angle of more than 30°, and in particular by even greater flank angles.

The invention is based in this regard on the realization that peak stresses in the bone cannot be reduced by having large flank angles. The reduction in peak stresses in the bone, achieved by the invention, is mainly based, when small flank angles are provided, on the fact that, in the mechanical interaction between the implant having a high modulus of elasticity compared to the bone, force can be transmitted from the thread groove via the flank into the bone. The bone in the groove is therefore relieved of stress.

In the dental implant according to the invention, the coronal, second bone anchoring surface is designed to prevent such a failure mechanism. To that end, grooves having a predetermined depth of more than 40 μm and with an angle of the groove flank surfaces to the radial direction of less than 30° are provided in this second bone anchoring surface. The groove flank surfaces are steeper here than is the case in prior art dental implants, with the result that, in addition to the stress-relieving effects in the transmission of force between the implant and the bone, as described in the foregoing, there is also a reduction in any wedging effect ensuing when pressure is applied to the dental implant in the axial direction, thus reducing any squeezing of osseointegrated bone portions out of the groove.

One advantageous feature of the invention is that the microthread or grooves can minimize the mechanical stresses in the bone during and after osseointegration, in that regions are produced in the (thread) grooves where the bone experiences a reduction in mechanical stresses, compared to an implant without a microthread or with a thread and grooves having larger dimensions (groove depth and width). The microthread, or the grooves, are designed biomechanically in such a way that minimal stresses are produced for soft and hard bone. To achieve this, the geometry of the groove and the flanks are designed in such a way that (when bone first makes contact with the groove) the peak stresses when the implant first makes contact with the bone remain low due to the transmission of force via the thread flanks (flank angle <30°). It is also advantageous when the stresses at the thread flank are similarly reduced by rounding at the thread flank

It is basically preferred that the flank surface of the groove is straight, and that it is straight over half of the groove depth in the outer area at least. The angle of the groove flank surfaces (also referred to hereinafter as the flank angle) is then defined as the angle between this straight area and the radially outward direction that is perpendicular to the axial, longitudinal axis of the dental implant. Alternatively, however, the groove flank surface may also be curved on the whole, or have curved portions. With such a thread geometry, the flank angle according to the thread geometry of the invention is defined as the angle between the secant line intersecting the groove flank surface at its outermost point and at the half-way point of the groove depth, and the radial direction perpendicular to the axial, longitudinal axis. When grooves have curved flank surfaces that are rounded not only outwardly but also in the groove root, the angle of the groove flank surface is defined as the angle between the radial direction perpendicular to the longitudinal axis and the tangent at the turning point between the rounding of the groove at the root of the groove and the outer rounding of the groove flank.

The groove flank surface preferably has a rectilinear flank portion extending from the outermost point of the groove to at least the half-way point in the groove depth, in particular to a point more than two thirds into the groove depth or to the groove bottom surface, and it should be understood in this regard that a rounding having a radius less than one fifth of the groove depth and provided at the transition between the groove bottom surface and the groove flank surface to prevent a wedging effect, is not to be understood as a curved portion of the groove flank surface within the meaning of the invention.

It is further preferred that, between the grooves, the second bone anchoring surface has a rectilinear surface portion extending in the axial direction. This surface portion is preferably cylindrical, but may also be conical or rounded. The second bone anchoring surface is preferably rotationally symmetric about the central longitudinal axis of the dental implant. In its outer circumferential portion, the second bone anchoring surface preferably has a rectilinear, cylindrical or conical outer envelope surface extending between the grooves and having no curved portions.

According to the invention, it has been found that a flank angle of 30° or less than 30° produces good resilience of the dental implant against compressive forces in the axial direction while at the same time not causing any strong wedging effect in the implant material itself, thus preventing any design-related weakening of the dental implant in the region of the grooves. However, an even smaller flank angle may be advantageous for certain variants. According to the invention, the dental implant may therefore be developed by making the angle between the groove flank surface and the radial direction less than 20°, less than 10°, less than 5° or 0°.

Reducing the flank angle is basically advantageous, in order to thus increase the resilience of the dental implant to axial compressive forces. However, such reduction is limited by the fact that an increasingly sharp angle is produced as a result between the flank surface and the outer surface in the second bone anchoring surface, and also because an increasingly sharp angle results between the groove bottom surface and the groove flank surface. Such sharp angles can result in a notching effect in the dental implant, signifying a design-related weakening of the material and which is disadvantageous, particularly given that the dental implant is subject in that region to constantly varying stresses. It is therefore preferred that a flank angle be selected which is greater than 0°, greater than 5°, greater than 10° and in particular greater than 20°, in order to avoid this disadvantage.

An optimized dental implant according to the invention may therefore have a flank angle in a range which is limited by the aforementioned upper and lower limits.

The groove depth must be understood as the distance between the outer envelope and the groove bottom. According to the invention, this distance is more than 40 micrometers and the groove depth is more than 50, 60, 70 or 80 micrometers, in particular. According to the invention, the groove depth should preferably not exceed a value of 80 micrometers, 90, 100, 120, 150, 200, 250, 300, 400 or 500 micrometers.

According to one embodiment, the second bone anchoring surface has at least three axially spaced apart grooves extending in the circumferential direction of said second bone anchoring surface or a thread groove extending circumferentially around said second bone anchoring surface and comprising at least three turns. Due to the arrangement of at least three circumferential grooves, or three turns of the thread, intraosseal anchoring in the coronal part of the dental implant is improved, without this necessitating a deepening of the groove or an increase in the thread depth. Any structural weakening of the dental implant at that location is thus avoided. It should be understood, as a basic principle, that the circumferential grooves are self-contained, whereas the turns of the thread are found in helical form in the second bone anchoring surface. The turns of the thread can be provided by a single-start thread in which the thread pitch is equal to the lead (the pitch being defined as the axial distance between two radial peaks of one and the same winding, the lead being defined as the distance between two adjacent peaks). However, a double-start thread may also be provided, in which the thread pitch is equal to the double of the lead, or a thread having three or more starts, in which the pitch is a respective multiple of the lead.

It is further preferred that the dental implant, as far as a thread and/or a thread groove, is rotationally symmetric about a central longitudinal axis extending in the longitudinal direction, and in that the first and the second bone anchoring surfaces preferably have a cylindrical or conical outer envelope. Such a rotationally symmetric geometry, except for the thread or thread groove, allows the dental implant to be implanted by a screwing movement, by screwing in the dental implant, which has proved to be a reliable method of implantation. It is particularly preferred that the first bone anchoring surface has a conical outer envelope and the second bone anchoring surface has a cylindrical outer envelope. An outer envelope is understood here to be the surface defining the maximum outer diameter of the respective surface portion. In a longitudinal or axial section of the dental implant, the outer envelope may be seen as a connecting line between the respective outer boundary surfaces of the respective bone anchoring surface.

It should be understood that the cylindrical or conical design may relate, in particular, to this outer envelope, i.e., to the maximum outer dimensions of the implant. In certain embodiments, however, it is also advantageous when the profile of a root of a thread cut into a bone anchoring surface, or the profile of the groove bottom in a bone anchoring surface is conical or cylindrical in the axial direction. A conical profile of the outer envelope or of the thread bottom/groove bottom basically causes displacement and hence compaction of the bone material when the prepared bore hole in the bone is cylindrical and smaller than the maximum outer diameter and the thread bottom or groove bottom diameter of the implant in this conical region. A conical shape for the outer envelope or thread/groove profile also allows the bore hole in the bone to be prepared in conical form, as a result of which the implant can be inserted into this conical bore hole in an axially oriented translational movement and can be fastened therein with only a few turns. This is considered advantageous in many case, in order to avoid any traumatization of the bone interface in the region of the implant due to a protracted insertion operation involving several full turns.

It is particularly preferred when the second bone anchoring surface has an outer cylindrical envelope. Such a cylindrical outer envelope in the second bone anchoring surface provides a particularly stable and extraction-resistant surface in the region of the denser bone tissue, combined with advantageous implantation involving only a few turns when the first bone anchoring surface has a conical outer envelope.

It is still further preferred that the first bone anchoring surface has a thread, in particular a thread with a depth which is greater than the depth of the groove in the second bone anchoring surface. Such a thread, in particular a thread having a thread depth greater than the depth of the groove in the second bone anchoring surface, is particularly advantageous for achieving efficacious mechanical anchorage also in the region in the apical part of the dental implant, where bone tissue is less dense, and for giving the person performing the implantation a practicable and reliable method of implantation.

It is still further preferred when the second bone anchoring surface has at least two circumferential grooves or one circumferential thread having at least two windings, and a groove width is formed between the radially outward ends of the flank surfaces of a groove, and a web having a web width is formed between the radially outward ends of the flank surfaces of adjacent grooves, and that the web width is at least half as large as the groove width. With this development of the invention, a particular ratio is defined between the geometry of the groove width and that of the web width in the second bone anchoring surface. The web width must be understood here as that part which lies at the outer maximum in a longitudinal cross-section of the implant, or in the case of an implant that is rotationally symmetric except for the thread or the thread groove, the part that has the maximum outer diameter, or as that part of the surface which does not contain the groove flank surfaces or the groove bottom. The groove width, in contrast, includes the groove flank surfaces and the groove bottom. Both the groove width and the web width are a dimension which is measured in the axial direction. Shortly after implantation of a dental implant, compacted bone substance typically abuts the region of the web width, i.e., the outer circumference of the second bone anchoring surface, thus ensuring primary stability, whereas the groove, in contrast, is not filled immediately after the operation with bone substance material that is capable of bearing loads. In the course of healing, however, the bone material hardens in the groove bottom, or grows into the groove bottom, thus providing particularly good mechanical protection, due to form-locking anchorage, against compressive forces acting on the dental implant in the axial direction. In order to absorb such compressive forces effectively by interaction with the steep groove flank surface, the bone structure must have a certain maximum width in the axial direction, or may not be less than a certain width.

For that reason, it is necessary to strike a careful balance between the primary stability being striven for and the secondary stability of the dental implant, when defining the ratio of web width to groove width. Whereas a larger web width is advantageous for primary stability, the small groove width that then results can absorb strong compressive forces in the axial direction to an inadequate extent only, as far as secondary stability is concerned. It has been found, according to the invention, that the steep flank angle and the previously described groove depth is particularly advantageous when the web width is half as large as the groove width. For certain applications, however, in particular when the quality of the bone in the region of the second bone anchoring surface is particularly good or particularly poor, other ratios may also be specified in accordance with the invention. More particularly, the web may be more than half as wide as the groove, for example it may have a width which is at least 60, 70 or 80% of the groove width. The web width may also be at least 100, 120 or 150% of the groove width, for example. Dental implants with this geometrical relation between the web width and the groove width are advantageous for achieving greater primary stability. In contrast to that, dental implants that are meant to have a greater secondary stability must be designed advantageously in such a way, according to the invention, that the web width is at most half as large as the groove width. In particular, the web width may amount at the most to 40, 30 or at most 20% of the groove width.

It is further preferred that the second bone anchoring surface has at least two circumferential grooves or one circumferential thread having at least two windings, and that a groove width is formed between the radially outward ends of the flank surfaces of a groove, and a web having a web width is formed between the radially outward ends of the flank surfaces of adjacent grooves, and that the sum of the web width and the groove width is not greater than 0.6 mm.

With this embodiment, in turn, an advantageous geometry with regard to the web width and groove width dimensions is defined, using the same definition of web width and groove width as in the embodiment described above. According to this embodiment, the web width and the groove width of a groove and an adjacent web have an axial length not exceeding 0.6 mm. By limiting in this way the maximum dimension that the sum of web width and groove width of an adjacent groove-web pair may have, the groove in the second bone anchoring surface is designed in a specifically fine manner. Such a fine groove geometry has proved to be particularly resilient against axial compressive forces. It should be understood that it may also be advantageous, in the case of dental implants for specific bone qualities, when the sum of the web width and the groove width is not greater than 0.2 mm, not greater than 0.3 mm, not greater than 0.4 mm, not greater than 0.5 mm or not greater than 0.6 mm.

It should also be understood that it is advantageous when the sum of the web width and the groove width is greater than 0.1 mm, at least, or the sum of the web width and the groove width is no less than 0.2 mm, 0.3 mm or 0.4 mm.

According to another preferred embodiment, the dental implant is delimited by a coronal end face, and said coronal end face is at a distance of less than 2 mm from the end of the radially outward groove flank surface which is closest to said coronal end face. The coronal end face of the dental implant delimits the dental implant coronally and typically serves as a support surface for an implant abutment. It can also define the limit to which the dental implant is to be screwed into the bone, i.e., the coronal end face defines the bone surface. In order to achieve reliable anchoring of the grooves in the second bone anchoring surface in the region of the dense bone tissue, when implanting the dental implant design according to the invention in such a manner, it is advantageous when said grooves do not exceed a predetermined distance of 2 mm from said coronal end face or bone boundary surface, that is, are as close as possible to the coronal end face. The distance is defined in such a way that it is measured as far the beginning of the groove flank surface that is coronally furthest away, or as far as the end of a thread representing the groove, the end being understood here as that region of the thread which has the full thread depth, and not some part of the thread which peters out with a decreasing thread depth. Embodiments in which said gaps is less than 2 mm may basically be advantageous as well, and embodiments are also advantageous, in particular, in which the distance is less than 1.8 mm, less than 1.6 mm, less than 1.4 mm, less than 1.2 mm, less than 1.0 mm, less than 0.8 mm, less than 0.6 mm, less than 0.5 mm, less than 0.4 mm, less than 0.3 mm or less than 0.25 mm. Larger distances may also be advantageous for certain kinds of implantation, in particular implantation in jawbone areas that have a pronounced and dense bone tissue portion extending deeply in the direction of implantation, and in such cases the distance may be selected specifically so that it is not less than 2.2 mm, not less than 2.4 mm or not less than 3 mm.

It is also preferred when the thread bottom is rounded.

The thread bottom may preferably extend by means of a continuous concave curvature from one flank surface to the other flank surface of the groove.

It is still further preferred that the outer edge of the groove flank surface is rounded.

These developments of the invention, with rounding of the groove bottom and/or of the outer edges of the groove flank surface, result in a bionic design for the implant that reduces local peaks in bone stress and which allows the bone, due to its lower modulus of elasticity compared to the implant, to grow inside the groove with reduced stress and to anchor itself after growth.

The dental implant according to the invention may be provided with a rough surface. Such surface roughness may be produced by etching, for example, or by blasting the surface of the dental implant. The surface roughness of the dental implant has the advantage that the bone tissue gains a better hold in the dental implant. When producing the surface roughness, in particular by etching or blasting, edges of the dental implant can also be simultaneously rounded.

A preferred embodiment of the dental implant according to the invention shall now be described in more detail with reference to the attached Figures. In the drawings,

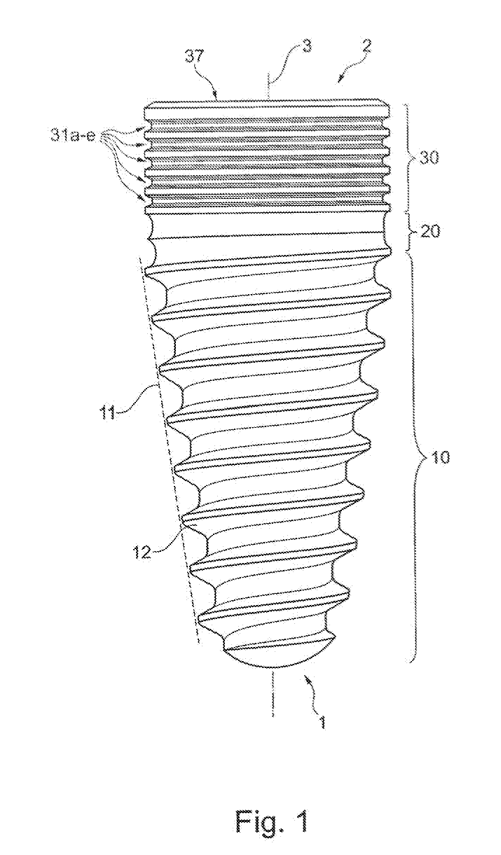

FIG. 1 shows a side view of a dental implant according to the invention before creating surface roughness.

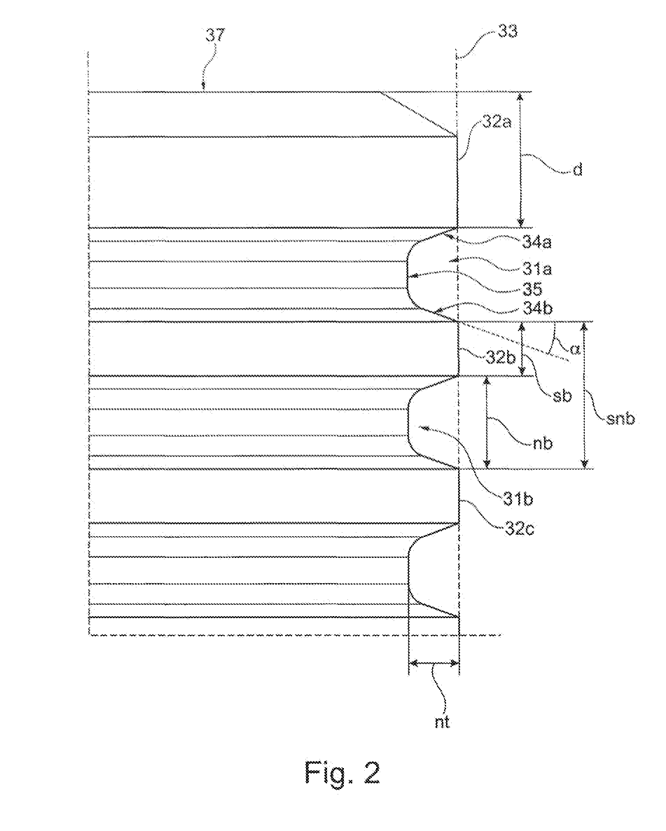

FIG. 2 shows a schematic view of part of a CAD drawing of the dental implant according to the invention, showing a preferred design of the groove in the second bone anchoring surface of the dental implant in FIG. 1.

The dental implant shown in FIG. 1 has an apical end 1 and a coronal end 2. A first bone anchoring surface 10 having a first bone anchoring surface extends from apical end 1. This bone anchoring surface is formed by a single-start coarse thread 12 and is defined as the surfaces of the groove flank surfaces, the groove bottom, and the web surfaces of said single-start thread 12.

The outer envelope 11 in the area of said first bone anchoring surface has a conical shape, with conical flaring in the apical to coronal direction. This conical profile is uniform, that is to say, there is no change in the steepness of the profile over the entire length of the first bone anchoring surface 10.

The first bone anchoring surface 10 extends as far as a transition portion 20, in which thread 12 in the first bone anchoring surface peters out. Said transition portion 20 lies between the first bone anchoring surface 10 and a second bone anchoring portion 30 having a second bone anchoring surface. The second bone anchoring surface has a total of five circumferential grooves 31 a-e that are axially spaced apart from each other. The groove depth of these five grooves 31 a-e is the same for every groove and is less than the thread depth of thread 12 in the first bone anchoring surface 10.

The geometrical design of grooves 31 a-e in the second bone anchoring surface shall now be described in more detail with reference to FIG. 2.

As can be seen from FIG. 2, the second bone anchoring surface has circumferential and self-contained webs 32 a-c which have a cylindrical outer surface defining the maximum outer diameter of the second bone anchoring surface and therefore outer envelope 33. Outer envelope 33 lies in the cylindrical surface that includes these surfaces of circumferential webs 32 a-c.

In the axial direction, the webs have a uniform width that is marked sb in the Figure.

A groove 31 a, b is formed between each pair of adjacent webs 32 a-c. Said groove 31 a,b is formed by two groove flank surfaces 34 a,b, each extending from each of the two adjacent webs 32 a-c toward the respective other web 32 a-c. In a longitudinal cross-sectional view, groove flank surfaces 34 a,b are rectilinear in the surface portion immediately adjoining webs 32 a-c. In the embodiment shown, angle a between said rectilinear portion and the radially outward direction perpendicular to the central longitudinal axis 3 of the dental implant is 20°.

Groove flank surface 34 a,b extends radially inward from the rectilinear portion into a rounded profile and ends at a groove bottom surface 35 having a cylindrical surface geometry and whose surface lies parallel to the central longitudinal axis of the dental implant.

In FIG. 2, the groove width is entered as dimension nb and is composed of the width of the two groove flank surfaces 34 a,b and of groove bottom 35 in the axial direction.

The groove also has a groove depth. Said groove depth is defined in FIG. 2 as dimension nt and is defined as half the outer diameter of the web surface minus half the outer diameter of the groove bottom surface.

As can also be seen from FIG. 2, the sum of web width sb and groove width nb is marked in the Figure as dimension snb. In the embodiment shown, said dimension snb is 0.3 mm.

Web width sb is 0.1 mm, and it is basically advantageous when web width sb is approximately the same as groove depth nt. In the embodiment shown, groove width nb is 0.2 mm, so the ratio of groove width to web width is 2 to 1.

At coronal end 2 of the dental implant, the latter has a coronal end face 37 which extends perpendicularly to the central longitudinal axis 3 of the dental implant.

As can also be seen from FIG. 2, the distance between coronal end face 37 of the dental implant and the end of the radially outward groove flank surface 34a which is closest to said coronal end face 37 is approximately 200 μm in the embodiment shown, and is marked d.

1. A dental implant, comprising an implant body which extends in a longitudinal direction from an apical end to a coronal end and which has
a first bone anchoring surface extending from the apical end to a transition portion lying between the apical and the coronal end, and
a second bone anchoring surface extending from the transition portion to the coronal end, said second bone anchoring surface having at least one groove extending in a circumferential direction of the second bone anchoring surface, said groove being defined in the radially inward direction by a groove bottom surface and on both sides in the axial direction by groove flank surfaces extending from the groove bottom surface to an outer surface,
wherein
the depth of the groove in the radial direction is greater than 40 micrometers and the angle of the groove flank surfaces to the radial direction is less than 30°.

2. The dental implant according to claim 1, wherein the second bone anchoring surface
has at least three axially spaced apart grooves extending in a circumferential direction of said second bone anchoring surface, or
a thread groove extending circumferentially around said second bone anchoring surface and comprising at least three turns.

3. The dental implant according to claim 1, wherein the dental implant, as far as a thread and/or a thread groove, is rotationally symmetric about a central longitudinal axis extending in the longitudinal direction, and in that the first and the second bone anchoring surfaces preferably have a cylindrical or conical outer envelope.

4. The dental implant according to claim 3, wherein the first bone anchoring surface has an outer envelope flaring, in particular conically, in the apical to coronal direction.

5. The dental implant according to claim 3, wherein the second bone anchoring surface has an outer cylindrical envelope.

6. The dental implant according to claim 1, wherein the first bone anchoring surface has a thread, in particular a thread with a depth which is greater than the depth of the groove in the second bone anchoring surface.

7. The dental implant according to claim 1, wherein the second bone anchoring surface has at least two circumferential grooves or one circumferential thread groove having at least two windings, and
a groove width is formed between the radially outward ends of the flank surfaces of a groove, and
a web having a web width is formed between the radially outward ends of the flank surfaces of adjacent grooves,
and that the web is at least half as wide as the groove.

8. The dental implant according to claim 1, wherein the second bone anchoring surface has at least two circumferential grooves or one circumferential thread groove having at least two windings and
a groove width is formed between the radially outward ends of the flank surfaces of a groove, and
a web having a web width is formed between the radially outward ends of the flank surfaces of adjacent grooves,
and that the sum of the web width and the groove width is not greater than 0.6 mm.

9. The dental implant according to claim 1, wherein the dental implant is delimited by a coronal end face and said coronal end face is at a distance of less than 2 mm from the end of the radially outward groove flank surface which is closest to said coronal end face.

10. The dental implant according to claim 1, wherein the thread bottom is rounded.

11. The dental implant according to claim 10, wherein the thread bottom extends by means of a continuous concave curvature from one flank surface to the other flank surface of the groove.

12. The dental implant according to claim 1, wherein the outer edge of the groove flank surface is rounded.
